(19) United States
(12) Patent Application Publication
(10) Pub. No.: US 2015/0200707 A1
(43) Pub. Date: Jul. 16, 2015

(54) ADAPTIVE SPREAD-SPECTRUM CLOCKING

(71) Applicant: Seagate Technology LLC, Cupertino, CA (US)

(72) Inventors: Byung Wook Kim, Gyeonggi-do (KR); Insu Lee, Gyeonggi-do (KR); Chaejung Lim, Gyeonggi-do (KR)

(73) Assignee: Seagate Technology LLC, Cupertino, CA (US)

(21) Appl. No.: 14/155,426

(22) Filed: Jan. 15, 2014

(51) Int. Cl. H04B 1/7097; H04L 7/033; H04B 1/709

(52) U.S. Cl. CPC H04B 1/7097; H04B 1/709; H04L 7/0331

(57) ABSTRACT

Technologies are described herein for adaptive spread-spectrum clocking to limit interference in a target band. Interference in the target band may be reduced by changing the frequency of the clock signal at a higher modulation rate for clock frequencies that interfere with, or are correlated to, the target band and changing the frequency of the clock signal at a lower modulation rate for the clock frequencies that are not correlated to the target band.

### BRIEF SUMMARY

The present disclosure relates to technologies for adaptive spread-spectrum clocking to limit interference in a target band of frequencies. According to some embodiments, a method for reducing interference of a spread-spectrum clock signal in the target band comprises changing the frequency of the clock signal at a higher modulation rate for clock frequencies that are correlated to the target band and changing the frequency of the clock signal at a lower modulation rate for the clock frequencies that are not correlated to the target band. A clock frequency is said to be correlated to the target band if the clock frequency and/or its harmonics potentially interfere with the target band of frequencies.

According to further embodiments, a computer-readable storage medium comprises processor-executable instructions that, when executed by a processor, cause the processor to cause the frequency of a clock signal to change at a higher modulation rate for clock frequencies correlated to the target band of frequencies and to cause the frequency of the clock signal to change at a lower modulation rate for the clock frequencies not correlated to the target band. According to further embodiments, an apparatus comprises a synchronous digital component and an adaptive spread-spectrum clocking circuit for generating a clock signal for the synchronous digital component. The adaptive spread-spectrum clocking circuit is configured to change a frequency of the clock signal at a higher modulation rate for clock frequencies correlated to a target band of frequencies and at a lower modulation rate for the clock frequencies not correlated to the target band.

These and other features and aspects of the various embodiments will become apparent upon reading the following Detailed Description and reviewing the accompanying drawings.

### BRIEF DESCRIPTION OF THE DRAWINGS

In the following Detailed Description, references are made to the accompanying drawings that form a part hereof, and that show, by way of illustration, specific embodiments or examples. The drawings herein are not drawn to scale. Like numerals represent like elements throughout the several figures.

FIG. 1 is a graph of radiated energy in the frequency domain at a harmonic of a clock frequency for a conventional clock signal and conventional spread-spectrum clocking, according to embodiments described herein.

FIG. 2 is a flow diagram showing one routine for performing adaptive spread-spectrum clocking to limit interference in a target band, according to embodiments described herein.

FIG. 3 is a block diagram showing an illustrative environment in which adaptive spread-spectrum clocking may be implemented, according to embodiments described herein.

FIG. 4 is a graph showing modulation profiles or schemes of conventional spread-spectrum clocking and adaptive spread-spectrum clocking, according to embodiments described herein.

FIG. 5 is a graph of radiated energy in the frequency domain at a harmonic of a clock frequency for adaptive spread-spectrum clocking, according to embodiments described herein.

FIG. 6 is a block diagram showing an illustrative adaptive spread-spectrum clocking circuit capable of implementing the methods and processes described herein.

### DETAILED DESCRIPTION

The following detailed description is directed to technologies for adaptive spread-spectrum clocking to limit interference in a target band. The circuitry of many electronic and computing devices include an oscillator or clock circuit that continuously generates a clock signal needed for the operation of synchronous digital components of the device, including processors, memory, communication components, and the like. For example, a hard-disk drive (“HDD”) device may include a clock circuit for generating the operational clock for internal dynamic random-access memory (“DRAM”). The DRAM clock circuit of the HDD may generate electromagnetic interference (“EMI”) that interferes with other components of the HDD or systems that implement the HDD and/or exceeds allowable EMI limits.

To limit EMI generated by the DRAM operational clock or other clock circuit, spread-spectrum clocking (“SSC”) may be utilized. SSC schemes vary the frequency of the clock signal in a limited range around a base frequency. The rate of change in the clock frequency is referred to as the “modulation rate” and the range over which the frequency is varied is referred to as the “deviation range.” Since SSC spreads EMI energy in the frequency domain through the deviation range, peak EMI at the base frequency and its harmonics may be significantly reduced. However, while peak EMI is reduced, the range of frequencies over which electromagnetic energy is radiated may be expanded around the base frequency and its harmonics.

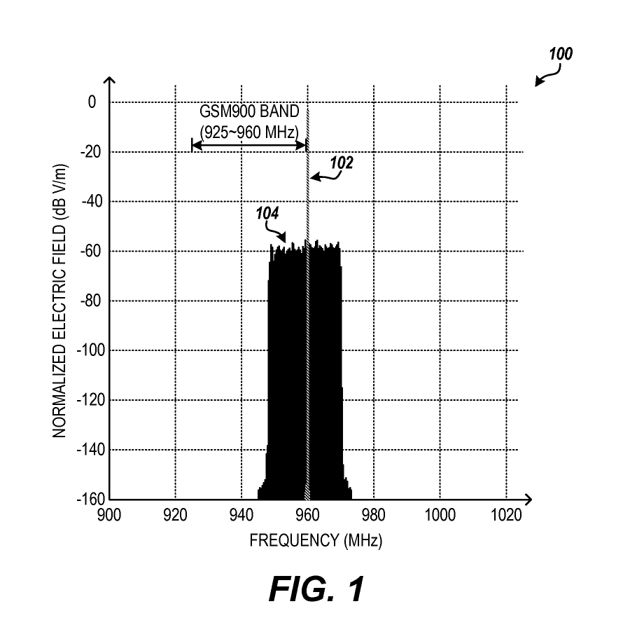

Many laptop computers, notebooks, tablets, PDAs, and other portable computing systems or devices include wireless communication components. The DRAM clock of an HDD suitable for inclusion in these portable systems may be configured so that the clock frequency and its harmonics do not fall into the communication bands of the wireless components. However, using SSC may cause the distributed frequency bands of electromagnetic energy to overlap with the wireless communication frequency bands and generate an unacceptable level of interference. For example, an HDD or other electronic device may use a 320 MHz DRAM clock and radiate electromagnetic energy on each harmonic of this frequency, such as 960 MHz as shown at 102 in FIG. 1.

A laptop computer or other portable system that implements the HDD may utilize wireless wide area networking (“WWAN”) for mobile Internet access. Commercial WWAN receiving bands are composed of several different frequency ranges, such as GSM850 (869-894 MHz), GSM900 (925-960 MHz), DCS1800 (1805-1880 MHz), PCS1900 (1930-1990 MHz), WCDMA2100 (2110-2170 MHz), and the like. Harmonics of the DRAM clock frequency (320 MHz) may not fall into any of the WWAN receiving bands, and thus the DRAM clock may not cause any WWAN interference. However, if the HDD or electronic device uses SSC for the DRAM clock with ±10,000 ppm deviation range and a 32 kHz modulation rate, the occupied frequency range of radiated electromagnetic field may be broadened, as shown at 104. This broadened range of frequencies for radiated electromagnetic energy may overlap with the WWAN receiving bands. For example, the broadened range of frequencies around the third harmonic of the 320 MHz clock frequency (960 MHz) may overlap the GSM900 band, as shown in FIG. 1, thus interfering with the WWAN communications in the laptop computer or other computing device. The range of frequencies with which minimal interference is desired is referred to herein as the “target band” (the GSM900 band, in this example).

Utilizing the technologies described herein, an adaptive SSC clocking mechanism may be implemented that reduces peak EMI levels while minimizing radiated electromagnetic energy in one or more target bands. According to embodiments, the adaptive SSC clocking mechanism varies the rate of change in clock frequency, or the “modulation rate,” in the SSC scheme. By applying a higher modulation rate for clock frequencies within the deviation range that produce interference in the target band and a lower modulation rate for clock frequencies that do not interfere, the electromagnetic energy radiated by the clock signal is spread in an uneven spectral fashion over the frequency domain, with lower radiated energy in the frequency range that is interfering with the target band, while retaining the advantages of SSC for lower peak EMI levels.

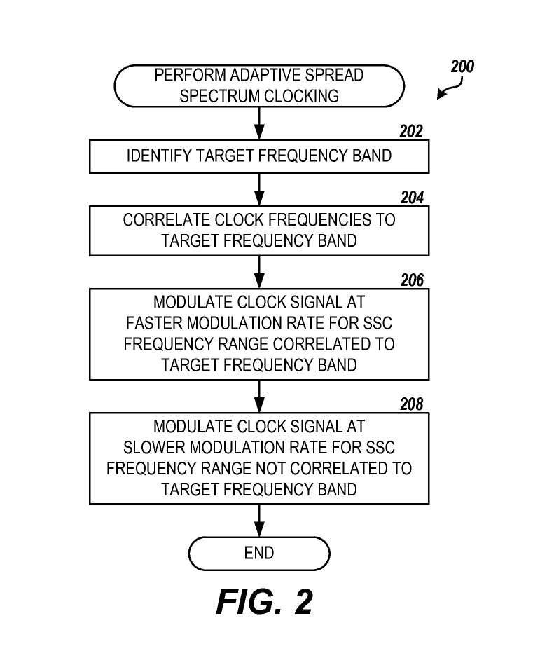

FIG. 2 provides an overview of adaptive spread spectrum clocking methods and processes described herein. Specifically, FIG. 2 illustrates one routine 200 for adaptive spread-spectrum clocking to limit interference in a target band, according to some embodiments. Portions of the routine 200 may be performed by the SSC clock circuit of an HDD or other electronic device, for example. According to some embodiments, the SSC clock mechanism may provide an operational clock for one or more components of the device, such as processors, memory, communication components, and/or the like. The SSC clock circuit may comprise hardware components, software components, or any combination of the two.

The routine 200 includes step 202, where a target band for the adaptive SSC mechanism is identified. The target band may comprise an operational frequency range of a component of the device or system implementing the device. For example, the target band may represent a WWAN receiving band utilized by a laptop computer or other portable system for mobile Internet access, such as the GSM900 receiving band (925-960 MHz). From step 202, the routine 200 proceeds to step 204, where the frequencies within the deviation range around the base frequency of the SSC scheme are correlated with the target band. For example, an SSC scheme with a base frequency of 320 MHz, a +/−10,000 ppm deviation range, and a 32 kHz modulation rate may radiate substantial electromagnetic energy around the third harmonic of the clock base frequency between approximately 950.4 MHz and 969.6 MHz. This frequency range overlaps a portion of the target band of 925-960 MHz, specifically between 950.4 MHz and 960 MHz.

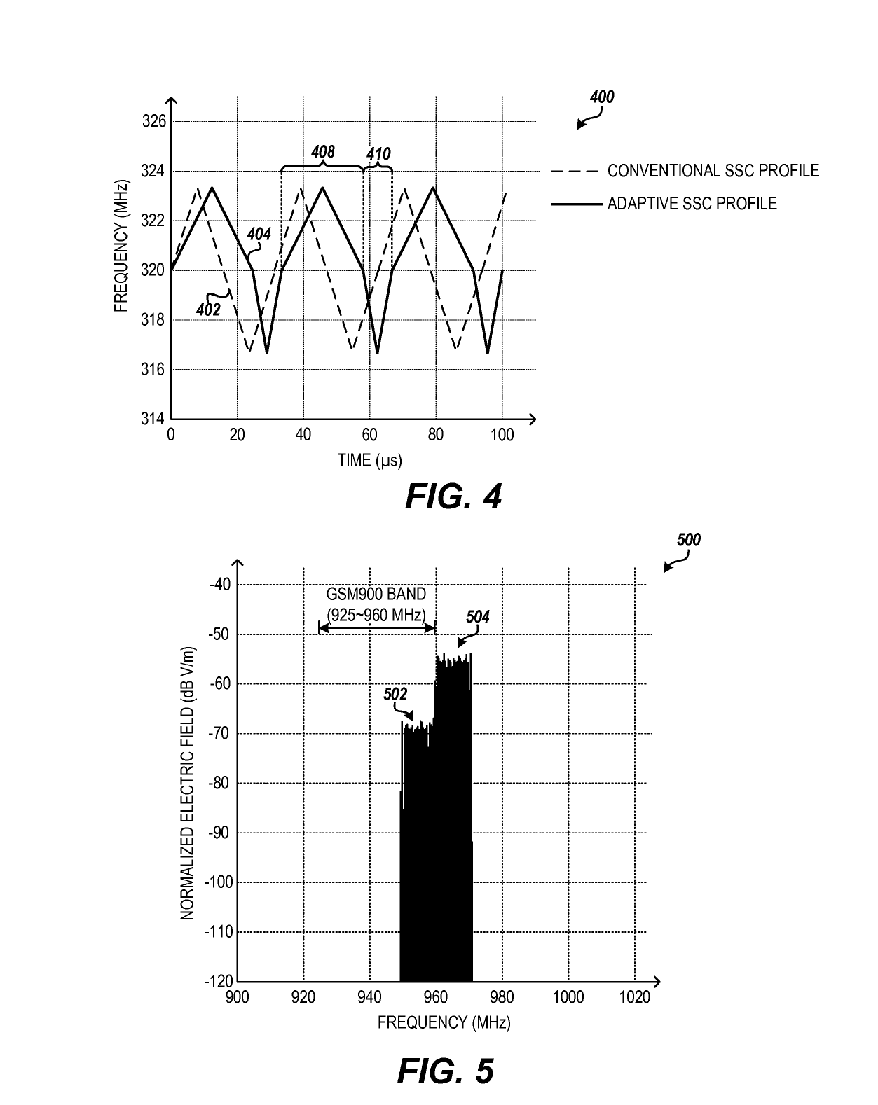

The routine 200 proceeds from step 204 to step 206, where the adaptive SSC mechanism modulates the clock signal at a higher modulation rate for those clock frequencies correlated with the target band. For example, the clock signal may be modulated at a frequency of 60 kHz for clock frequencies between approximately 316.8 MHz and 320 MHz (correlated to the 950.4-960 MHz overlap with the target band identified in step 204 above). Conversely, at step 208, the adaptive SSC mechanism modulates the clock signal at a lower modulation rate for those clock frequencies not correlated with the target band. Continuing the example from above, the clock signal may be modulated at a frequency of 20 kHz for clock frequencies between 320 MHz and 323.2 MHz. Because the clock signal spends less time in the frequency range correlated with the target band and more time in the frequency range not correlated with the target band, less electromagnetic energy is radiated in the frequency domain that overlaps with the target band (around the base frequency and/or its harmonics), as will be described in more detail below in regard to FIGS. 4-5. From step 208, the routine 200 ends.

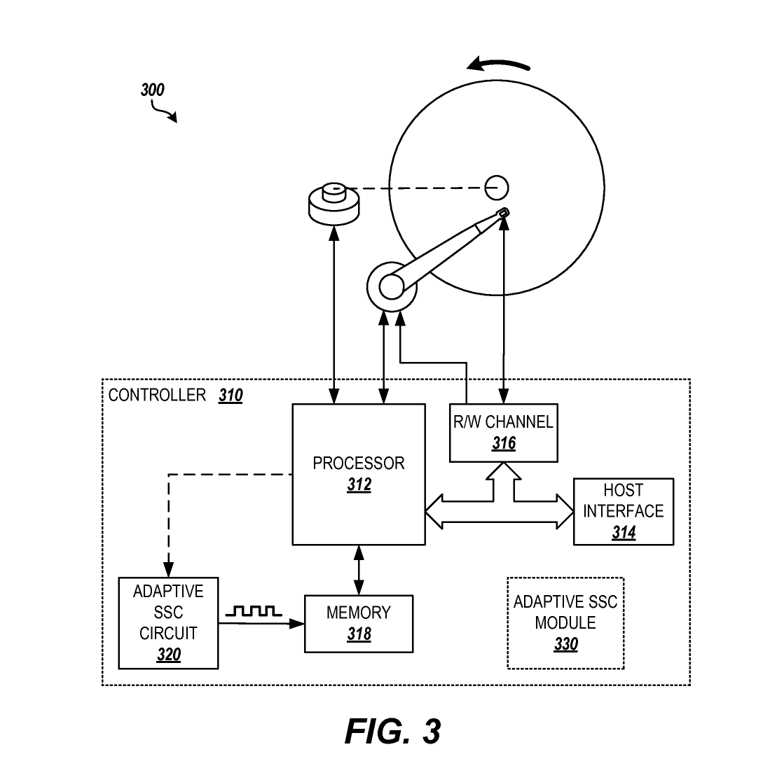

FIG. 3 and the following description are intended to provide a general description of a suitable environment in which the embodiments described herein may be implemented. In particular, FIG. 3 shows an illustrative electronic device, such as an HDD device 300, along with hardware, software and components for performing adaptive spread-spectrum clocking to limit interference in a target band, according to the embodiments provided herein. The HDD device 300 may include a controller 310 that controls the operations of the device. The controller 310 may include a processor 312 to monitor and control the operations of the HDD device 300. The controller 310 may further include a host interface 314 allowing the HDD device 300 to communicate with a host system or other components, such as a server computer, personal computer (“PC”), laptop, tablet, game console, set-top box or any other electronics device that can be communicatively coupled to the HDD device 300 to store and retrieve data from the device. The controller 310 may further comprise a read/write channel 316 through data is written to and read from the magnetic recording channel of the HDD device 300

The controller 310 may further include a computer-readable storage medium or “memory” 318 for storing processor-executable instructions, data structures and other information. According to some embodiments, the memory 318 may comprise a dynamic random access memory (“DRAM”) or synchronous dynamic random access memory (“SDRAM”). In further embodiments, the memory 318 may comprise a non-volatile memory, such as read-only memory (“ROM”) and/or FLASH memory. The memory 318 may store a firmware that comprises commands and data necessary for performing the operations of the HDD device 300. According to some embodiments, the memory 318 may store processor-executable instructions that, when executed by the processor 312, perform the routine 200 for performing adaptive spread-spectrum clocking to limit interference in a target band, as described herein.

In addition to the memory 318, the environment may include other computer-readable media storing program modules, data structures and other data described herein for performing adaptive spread-spectrum clocking in the HDD device 300. It will be appreciated by those skilled in the art that computer-readable media can be any available media that may be accessed by the controller 310 or other computing system, including computer-readable storage media and communications media. Communications media includes transitory signals. Computer-readable storage media includes volatile and non-volatile, removable and non-removable storage media implemented in any method or technology for the non-transitory storage of information. For example, computer-readable storage media includes, but is not limited to, RAM, ROM, erasable programmable ROM (“EPROM”), electrically-erasable programmable ROM (“EEPROM”), FLASH memory or other solid-state memory technology, compact disc ROM (“CD-ROM”), digital versatile disk (“DVD”), high definition DVD (“HD-DVD”), BLU-RAY or other optical storage, magnetic cassettes, magnetic tape, magnetic disk storage or other magnetic storage devices and the like.

According to embodiments, the controller further includes an adaptive spread-spectrum clocking (“SSC”) circuit 320. The adaptive SSC circuit 320 may provide an operational clock signal to one or more other components of the controller 310 or HDD device 300. For example, the adaptive SSC circuit 320 may provide an operation clock signal to DRAM memory 318 of the controller 310. The adaptive SSC circuit 320 may be implemented in hardware, software, or a combination of the two. In some embodiments, the operation and/or parameters of the adaptive SSC circuit 320 may be configured and controlled by the processor 312.

In further embodiments, the environment may include an adaptive SSC module 330. The adaptive SSC module 330 may perform the methods and processes described herein for performing adaptive spread-spectrum clocking to limit interference in a target band. According to some embodiments, the adaptive SSC module 330 may be implemented in the adaptive SSC circuit and/or the controller 310 as hardware, software, or any combination of the two. For example, the adaptive SSC module 330 may be stored in the memory 318 as part of the firmware of the HDD device 300 and may be executed by the processor 312 for performing the methods and processes described herein. The adaptive SSC module 330 may alternatively or additionally be stored in other computer-readable media accessible by the controller 310.

It will be appreciated that the structure and/or functionality of the HDD device 300 may be different than that illustrated in FIG. 3 and described herein. For example, the processor 312, read/write channel 316, memory 318, adaptive SSC circuit 320 and other components and circuitry of the HDD device 300 may be integrated within a common integrated circuit package or distributed among multiple integrated circuit packages. Similarly, the illustrated connection pathways are provided for purposes of illustration and not of limitation, and some components and/or interconnections may be omitted for purposes of clarity. It will be further appreciated that the HDD device 300 may not include all of the components shown in FIG. 3, may include other components that are not explicitly shown in FIG. 3 or may utilize an architecture completely different than that shown in FIG. 3. Further, the HDD device 300 is described for illustrative purposes, and it will be further appreciated that the embodiments described herein may be applied to any electronic device implementing spread-spectrum clocking for one or more components.

FIG. 4 shows at 402 a triangular frequency modulation profile associated with a conventional SSC scheme for a clock signal having base frequency of 320 MHz, a deviation range of ±10,000 ppm and a modulation rate of 32 kHz. FIG. 4 further shows at 404 a frequency modulation profile for an adaptive SSC scheme according to embodiments described herein. The adaptive SSC profile 404 shown is for a 320 MHz clock configured to reduce interference in a target band of 925-960 MHz, corresponding to the GSM900 receiving band from the example above. In this adaptive SSC scheme, the rate of change in clock frequency, or “modulation rate,” is higher for those clock frequencies in the deviation range that correlate to the target band than those clock frequencies that do not interfere.

Specifically, the modulation rate of the adaptive SSC profile 404 is higher, e.g. 60 kHz, for clock frequencies in the 316.8-320 MHz frequency range 410 (correlated to the 950.4-960 MHz overlap of the third harmonic with the target band) and lower, e.g. 20 kHz, for clock frequencies in the 320-323.2 MHz frequency range 408. Since the clock signal will spend less time in the lower half (316.8-320 MHz) of the deviation range and more time in the upper half (320-323.2 MHz), the amount of electromagnetic energy radiated in the lower half of the clock frequency range will be less than that radiated in the upper half of the clock frequency range. This is also true for all harmonics of 320 MHz base frequency.

FIG. 5 illustrates the distribution of the radiated electromagnetic energy around the third harmonic (960 MHz) from the clock signal generated using the adaptive SSC profile 404 described above. As may be seen in the figure, energy radiated in the target band (GSM900 receiving band of 925-960 MHz), as shown at 502, is less than that radiated outside of the target band, as shown at 504. It will be appreciated that similar energy distribution patterns as that shown in FIG. 5 would be generated around the base clock frequency of 320 MHz as well as the other harmonics, such as 640 MHz, 1280 MHz, and the like. In further embodiments, the adaptive SSC profile 404 may comprise three, four, or more modulation rates according to the target band(s) for which it was configured. For example, the modulation rate may be 60 kHz for clock frequencies between 316.8 MHz and 318.4 MHz; 55 kHz for clock frequencies between 318.4 MHz and 320 MHz; 25 kHz for clock frequencies between 320 MHz and 321.6 MHz, and 20 kHz for clock frequencies between 321.6 MHz and 323.2 MHz.

The higher and lower modulation rates used in the adaptive SSC profile 404 may be based on the suitability of the SSC clock signal for the components utilizing the clock. For example, for the DRAM clock described herein, the DDR2 specification of modulation rates for SSC is from 20 kHz to 60 kHz. The higher and lower modulation rates may be based on other factors as well, such as the base frequency of the clock signal, the deviation range of the SSC to be used, the target band(s), and the like. The optimal high and low modulation rates may be determined by formulaic calculation, simulation, and/or experimentation considering EMI peak levels and the level of interference present in the target band(s). Practical limits on the modulation rates may also be considered. For example, if a modulation rate is too slow, such as lower than 20 kHz, it may cause audible interference due to demodulation by non-linearity of the circuit components. If a modulation rate is too fast, it can cause signal timing issues or excessive jitter and/or loss of DLL lock.

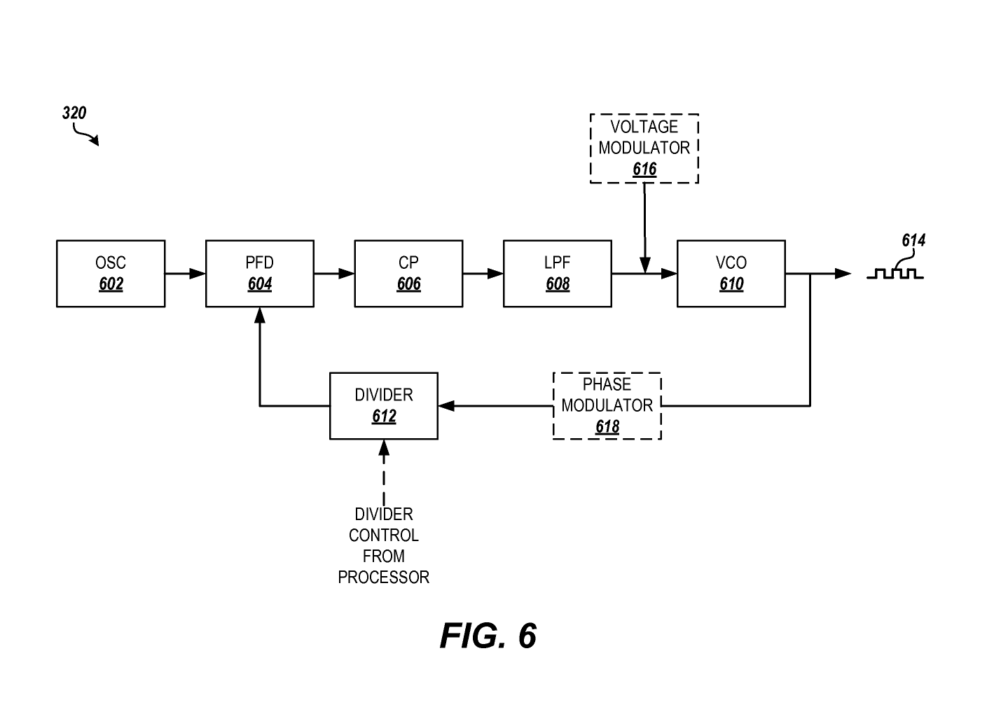

FIG. 6 shows an illustrative adaptive SSC circuit 320 for generating a clock signal having an adaptive SSC profile 404 similar to that described above in regard to FIG. 4, according to some embodiments. Specifically, the adaptive SSC circuit 320 comprises a phase-locked loop (“PLL”) circuit, comprising an oscillator 602, a phase frequency detector 604, a charge pump 606, a low-pass filter 608, a voltage-controlled oscillator 610 and a divider 612. The output clock signal 614 is fed into divider 612 for frequency down conversion. The phase frequency detector 604 compares phase between a reference clock produced by the oscillator 602 and the output signal of the divider 612 and produces an error signal between them. The charge pump 606 and the low-pass filter 608 make the voltage input to the voltage-controlled oscillator 610 proportional to the error signal, thus changing the output frequency. This PLL feedback circuit allows the generation of an output clock signal 614 that follows the reference clock from the oscillator 602 in phase and that may be multiple times the reference clock frequency.

The PLL circuit may be modified to produce the adaptive SSC profiles 404 described herein by the addition of one or more components in the feedback loop. According to some embodiments, the voltage input to the voltage-controlled oscillator 610 may be modulated directly by a voltage modulator 616 to produce the SSC clock signal with the adaptive SSC profiled 404. Output frequency of the voltage-controlled oscillator 610 is controlled by the value of the input voltage. For example, higher voltage input to voltage-controlled oscillator 610 may cause lower output frequency. In some embodiments, voltage output of the voltage modulator 616 may be controlled by the adaptive SSC module 330 via the processor 312 so that output frequency of the voltage-controlled oscillator 610 follows the desired adaptive SSC profile 404. Parameters describing the adaptive SSC profile 404, including the high and low modulation rates, cycle timing values, and/or the like, may be stored as part of the adaptive SSC module 330 in the firmware of the controller 310 described above in regard to FIG. 3. In other embodiments, the control of the voltage modulator 616 based on the parameters describing the desired adaptive SSC profile 404 may be implemented in the adaptive SSC circuit 320.

In further embodiments, a processor-controlled phase modulator 618 may be added between the voltage-controlled oscillator 610 and the divider 612. By changing phase delay of the voltage-controlled oscillator 610 output, the error signal from the phase frequency detector 604 may be changed to cause the desired frequency changes in the output clock signal 614 from the voltage-controlled oscillator 610. The adaptive SSC module 330 may control the phase delay of the phase modulator 618 so that the output frequency of the voltage-controlled oscillator 610 follows the desired adaptive SSC profile 404. In other embodiments, the control of the phase modulator 618 based on the parameters describing the desired adaptive SSC profile 404 may be implemented in the adaptive SSC circuit 320.

In further embodiments, the divider 612 may be controlled by the processor to change the dividing rate of the divider. By changing the dividing rate, the error signal from the error signal from the phase frequency detector 604 may be changed to cause the desired frequency changes in the output clock signal 614 from the voltage-controlled oscillator 610. The adaptive SSC module 330 may control the dividing rate of the divider 612 via the processor so that the output frequency of the voltage-controlled oscillator 610 follows the desired adaptive SSC profile 404. In other embodiments, the control of the dividing rate of the divider 612 based on the parameters describing the desired adaptive SSC profile 404 may be implemented in the adaptive SSC circuit 320.

Based on the foregoing, it will be appreciated that technologies for adaptive spread-spectrum clocking to limit interference in a target band are presented herein. While embodiments are described herein in regard to an HDD device, it will be appreciated that the embodiments described in this disclosure may be utilized in any electronic device that contains a clock signal generator that radiates EMI, including storage devices, computing devices, communication devices, networking devices, and the like. Further, while the embodiments described herein refer to reduction of interference of a 320 MHz clock signal in wireless communication bands, it will further appreciated that the embodiments described in the disclosure may be utilized to produce adaptive SSC profiles 404 with reduced radiation in any target band or bands based on any clock frequency and/or harmonics thereof. The above-described embodiments are merely possible examples of implementations, merely set forth for a clear understanding of the principles of the present disclosure.

The logical steps, functions or operations described herein as part of a routine, method or process may be implemented (1) as a sequence of processor-implemented acts, software modules or portions of code running on a controller or computing system and/or (2) as interconnected machine logic circuits or circuit modules within the controller or electronic device. The implementation is a matter of choice dependent on the performance and other requirements of the system. Alternate implementations are included in which steps, operations or functions may not be included or executed at all, may be executed out of order from that shown or discussed, including substantially concurrently or in reverse order, depending on the functionality involved, as would be understood by those reasonably skilled in the art of the present disclosure.

It will be further appreciated that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

Many variations and modifications may be made to the above-described embodiments without departing substantially from the spirit and principles of the present disclosure. Further, the scope of the present disclosure is intended to cover any and all combinations and sub-combinations of all elements, features and aspects discussed above. All such modifications and variations are intended to be included herein within the scope of the present disclosure, and all possible claims to individual aspects or combinations of elements or steps are intended to be supported by the present disclosure.

What is claimed is:

1. A method for reducing interference of a spread-spectrum clock signal in a target band of frequencies, the method comprising:
changing a frequency of the clock signal at a higher modulation rate for clock frequencies correlated to the target band; and
changing the frequency of the clock signal at a lower modulation rate for the clock frequencies not correlated to the target band.

2. The method of claim 1, wherein the clock frequencies correlated to the target band have harmonics falling within the target band.

3. The method of claim 1, wherein changing the frequency of the clock signal at the higher and lower modulation rates comprises modulating an input voltage of a voltage-controlled oscillator in a phase-locked loop clock circuit generating the clock signal.

4. The method of claim 1, wherein changing the frequency of the clock signal at the higher and lower modulation rates comprises changing a phase delay of an output of a voltage-controlled oscillator in a phase-locked loop clock circuit generating the clock signal.

5. The method of claim 1, wherein changing the frequency of the clock signal at the higher and lower modulation rates comprises changing a divider rate of a divider in a phase-locked loop clock circuit generating the clock signal.

6. The method of claim 1, wherein an adaptive spread-spectrum clocking profile comprising the higher modulation rate and the lower modulation rate is applied to the clock signal by a processor-controlled clock circuit, and wherein parameters describing the adaptive spread-spectrum clocking profile are stored in a firmware of an electronic device containing the processor.

7. The method of claim 6, wherein the electronic device is a hard disk drive device.

8. The method of claim 1, wherein the clock signal comprises a dynamic random-access memory (“DRAM”) operational clock.

9. The method of claim 8, wherein the higher modulation rate is substantially 60 kHz and the lower modulation rate is substantially 20 kHz.

10. The method of claim 1, wherein the clock frequencies are changed at a single higher modulation rate for the entire range of clock frequencies correlated to the target band and at a single lower modulation rate for the entire range of clock frequencies not correlated to the target band.

11. A computer-readable storage medium having processor-executable instructions stored thereon that, when executed by a processor, cause the processor to:
cause a frequency of a clock signal to change at a higher modulation rate for clock frequencies correlated to a target band; and
cause the frequency of the clock signal to change at a lower modulation rate for the clock frequencies not correlated to the target band.

12. The computer-readable storage medium of claim 11, further storing parameters describing an adaptive spread-spectrum clocking profile applied to the clock signal by the processor, the adaptive spread-spectrum clocking profile comprising at least the higher modulation rate and the lower modulation rate.

13. The computer-readable storage medium of claim 11, wherein the processor and the computer-readable storage medium are components of a hard disk device.

14. The computer-readable storage medium of claim 11, wherein the clock signal comprises a dynamic random-access memory (“DRAM”) operational clock.

15. The computer-readable storage medium of claim 11, wherein the target band represents a wireless communication frequency band.

16. An apparatus comprising:
a synchronous digital component; and
an adaptive spread-spectrum clocking circuit for generating a clock signal for the synchronous digital component, the adaptive spread-spectrum clocking circuit configured to
change a frequency of the clock signal at a higher modulation rate for clock frequencies correlated to a target band; and
change the frequency of the clock signal at a lower modulation rate for the clock frequencies not correlated to the target band.

17. The apparatus of claim 16, wherein the adaptive spread-spectrum clocking circuit comprises a phase-locked loop circuit and a voltage modulator, and wherein changing the frequency of the clock signal at the higher and lower modulation rates comprises modulating by the voltage modulator an input voltage of a voltage-controlled oscillator in the phase-locked loop circuit.

18. The apparatus of claim 16, wherein the adaptive spread-spectrum clocking circuit comprises a phase-locked loop circuit and a phase modulator, and wherein changing the frequency of the clock signal at the higher and lower modulation rates comprises changing by the phase modulator a phase delay of an output of a voltage-controlled oscillator in the phase-locked loop circuit.

19. The apparatus of claim 16, wherein the adaptive spread-spectrum clocking circuit comprises a phase-locked loop circuit, and wherein changing the frequency of the clock signal at the higher and lower modulation rates comprises changing a divider rate of a divider in the phase-locked loop circuit.

20. The apparatus of claim 16, wherein the synchronous digital component comprises a dynamic random-access memory (“DRAM”) and the target band represents a wireless communication frequency band.
